(19) United States
(12) Patent Application Publication
(10) Pub. No.: US 2026/0104315 A1
(43) Pub. Date: Apr. 16, 2026

(54) DRIVE UNIT FOR A TEST BENCH FOR TESTING AN ELECTRIC AXLE DRIVE MODULE FOR A MOTOR VEHICLE AND TEST BENCH

(71) Applicant: ZF Friedrichshafen AG, Friedrichshafen (DE)

(72) Inventors: Christian HELL, Untergriesbach (DE); Matthias JUSE, Schardenberg (AT)

(73) Assignee: ZF Friedrichshafen AG, Friedrichshafen (DE)

(21) Appl. No.: 19/351,727

(22) Filed: Oct. 7, 2025

(30) Foreign Application Priority Data
Oct. 10, 2024 (DE) 10 2024 209 884.1

(51) Int. Cl. G01M 13/025; G01M 13/027; G01M 17/007

(52) U.S. Cl. CPC G01M 13/025; G01M 13/027; G01M 17/007

(57) ABSTRACT

A drive unit (100) is provided for a test bench (200) for testing an electric axle drive module (240) for a motor vehicle. The drive unit has an electric drive motor (110) and a frame (130), where the drive motor (110) is accommodated radially by the frame (130) and is held in the frame (130) in such manner that it can drive an input shaft (241) of an axle drive module (240). The drive unit (100) is characterized in that the frame (130) has at least one opening (140) designed to guide a drive output shaft (242, 243) of the axle drive module (240) through the frame (130), parallel to the drive motor (110). The drive unit can be part of a corresponding test bench.

### RELATED APPLICATIONS

This application claims the benefit of and right of priority under 35 U.S. C. § 119 to German Patent Application no. 10 2024 209 884.1, filed on 10 Oct. 2024, the contents of which are incorporated herein by reference in its entirety.

### FIELD OF THE DISCLOSURE

The invention relates to a drive unit for a test bench for testing an electric axle drive module for a motor vehicle and to a corresponding test bench.

### BACKGROUND

Transmission test benches, or drivetrain test benches for testing motor vehicle transmissions, or complete motor vehicle drivetrains, are basically known from the prior art. Such test benches are typically used for quality control purposes, in order to detect functional defects in drivetrains at an early stage by means of a series of load tests. Typical functional defects are produced, for example, by components affected by play, such as gearwheels, synchronizer rings, synchronizer bodies, disk brake disks or shafts, which are misaligned and can be excited into vibrations. During such quality control processes, as a rule the acoustic behavior and shifting properties are tested. Furthermore, however, such test benches are also used during the development and continual improvement of motor vehicle drivetrains.

In this connection a particular challenge is posed by electrically driven axle modules, since owing to their structure, there is as a rule only a small radial distance between a transmission input shaft and a transmission output shaft, and the ability of the two shafts to be coupled to one another on a test bench, usually a so-termed multiple-machine test bench, is therefore made more difficult. Furthermore, such electric axle modules typically require comparatively high input rotation speeds, and correspondingly this makes severe demands on the vibration-damping properties and the rigidity of the test bench.

In that connection, from DE 10 2022 202 300 A1 a test bench for a drivetrain of a motor vehicle is known, which comprises a first loading motor, a second loading motor, and a base frame with receiving means for the test object. The test bench further comprises a first motor holder for receiving the first loading motor and a second motor holder for receiving the second loading motor, wherein a first motor shaft of the first loading motor and a second motor shaft of the second loading motor can be connected to shafts of the test object so that the drive-shafts of the test object can be acted upon by torques and rotation speeds.

From DE 10 2022 202 301 A1 a test bench for a drivetrain of a motor vehicle is also known, which comprises at least one electric loading motor and a support frame, wherein the at least one electric loading motor is arranged with a front end on a motor holder of the support frame. The motor holder can be adjusted vertically and horizontally to enable the at least one electric loading motor to be positioned as desired.

The as-yet unpublished document DE 10 2024 202 155.5 by the present applicant shows a drive unit for a test bench for testing an electric axle drive module for a motor vehicle, in particular for a truck, the drive unit comprising an electric drive motor and a transmission drivingly connected downstream from the drive motor, with an input shaft and an output shaft. The transmission is designed in such manner that between the input shaft and the output shaft there is a radial offset, which is larger than half the diameter of the drive motor. In that way, the output shaft of the transmission can be coupled to an input shaft of the axle drive module. Moreover, the downstream transmission can be swiveled about the input shaft, and that simplifies the positioning of the drive unit relative to the axle drive module.

### SUMMARY

However, the known motor vehicle test benches have the disadvantage that owing to the proximity of the shafts to one another and the high rotation speeds they only enable testing of an electric axle drive module when the axle drive module is driven by an electric motor belonging to the axle drive module itself or when a special transmission—as for example according to DE 10 2024 202 155.5—is used, which provides for a radial offset. Such transmissions, however, are comparatively costly, they do not enable a precise determination of the torque acting upon the test object, and they are hardly suitable for the testing of electric axle drive modules for passenger cars.

A purpose of the present invention is to propose an improved drive unit for a test bench for testing an electric axle drive module of a motor vehicle.

According to the invention, that objective is achieved by the drive unit for a test bench for testing an electric axle drive module for a motor vehicle as disclosed herein. Advantageous design features will be apparent in light of the present disclosure.

The invention relates to a drive unit for a test bench for testing an electric axle drive module for a motor vehicle, comprising an electric drive motor and a frame, wherein the drive motor is accommodated radially by the frame and is held in the frame in such manner that it can drive an input shaft of an axle drive module.

Thus, the invention describes a drive unit which is designed to drive an electric axle drive module for a testing process on a test bench. The drive unit according to the invention is preferably part of the test bench. Correspondingly, the test bench is designed as a drivetrain test bench and is suitable for testing the electric axle drive module before the electric motor required for driving it is fitted onto it.

The electric axle drive module is provided and is suitable for driving a motor vehicle, in particular a passenger car.

When fully assembled, the axle drive module as a rule comprises an electric motor, a transmission, a differential and two drive output shafts, which when the axle module is operating constitute the wheel shafts of the motor vehicle. By virtue of their intended use for driving vehicles and in particular for being fitted in vehicles in the area of their rear axle, they are typically designed comparatively compactly so that an input shaft of the transmission of the axle drive module is only a very small distance away from the drive output shafts of the transmission of the axle drive module.

Alternatively, the axle drive modules described can also be used in vehicles in the area of their front axles, though this does not entail any essentially different structure of the axle drive module.

Rather, both in the area of the rear axle and in the area of the front axle the prerequisites are very similar or even identical, since in both cases the axle drive modules have to be of compact structure. In particular, this is also achieved thanks to the use of rapidly rotating and therefore compactly built electric motors, which in order to support the rotation speed in tum rely upon a gear ratio stage with at least one comparatively small gearwheel, so that the radial axial separation between the input shaft of the transmission of the axle drive module and the drive output shafts of the transmission is necessarily small as described.

Thus, in particular owing to its structure and especially to its design, the drive unit according to the invention is suitable, despite the restricted space available, for producing a driving connection to an input shaft of the transmission of the axle drive module.

For that purpose, the drive unit contains an electric drive motor and a frame which is designed to carry the drive motor. Preferably the frame has vibration-damping properties and is made particularly rigid in order to make possible even high drive input rotation speeds of the drive motor up to 30,000 rpm and more. Accordingly, a resonant frequency of the drive unit is preferably at least 500 Hz.

The electric drive motor advantageously is in the form of an electric motor. Electric motors are comparatively compact and in particular, compared with internal combustion engines, they have a broad spectrum of rotation speeds and advantageously produce their maximum torque over a wide rotation speed range.

Advantageously the drive motor has a motor housing, which accommodates the drive motor and in particular limits it radially.

The frame houses the drive motor radially and preferably makes flat contact with the bearing plates of the drive motor. In that way vibrations of the drive motor, which occur preferentially in the bearing plates, can be damped in a targeted manner and effectively.

Advantageously, the frame comprises cast holders for the bearing plates of the drive motor, which embrace and support the bearing plates radially. For example, the drive motor can have a conical outer shape, particularly in the area of the bearing plates, and the holders can be adapted precisely to the conical shape of the drive motor.

A motor shaft of the drive motor can be made sufficiently long to project out of the frame far enough to be drivingly coupled to the input shaft of the axle drive module, so that the drive motor can drive the axle drive module.

Alternatively, preferably, the motor shaft of the drive motor can be coupled to an intermediate shaft, which can in particular also be mounted in a vibration-damping and rigid manner in the frame. In that case the input shaft of the axle drive module can be coupled by way of the intermediate shaft to the motor shaft of the drive motor, Thus, in the context of the invention it is not necessary for the motor shaft of the drive motor to be directly coupled to the input shaft of the axle drive module. Rather, the coupling can be formed via an intermediate shaft. However, coupling via a gearwheel stage is not provided according to the invention.

The coupling of the motor shaft to the input shaft or to the intermediate shaft, and the coupling of the intermediate shaft to the input shaft are preferably formed by means of a flange.

Preferably, it is provided that the motor shaft or the intermediate shaft comprise(s) a compensation element, such that the compensation element is designed to be coupled to the input shaft of the axle drive module.

The compensation element serves mainly to compensate any slight axial misalignment between the motor shaft or intermediate shaft and the input shaft of the axle drive module.

The compensation element can for example be in the form of an offset coupling.

The drive motor is preferably designed to operate at rotation speeds of 30,000 rpm or more.

In particular the drive motor is designed to operate at rotation speeds of 20,000 rpm, 25,000 rpm, 30,000 rpm, 35,000 rpm, and 40,000 rpm.

According to the invention, it is now provided that the frame has at least one opening which is designed to guide a drive output shaft of the axle drive module through the frame parallel to the drive motor.

Preferably, the opening extends axially all the way through the frame, i.e., it forms a passage from a front side of the frame to rear side of the frame.

This makes it possible for a drive output shaft of the axle drive module to be passed through the frame radially offset and parallel to the drive motor. This in turn first enables the drive unit according to the invention to be used to drive the axle drive module, since otherwise the drive output shaft of the axle drive module, which owing to the compact structure of the axle drive module is arranged radially close to the input shaft, would block access for a driving coupling of the drive unit to the input shaft.

Preferably, the axle drive module comprises two drive output shafts extending coaxially with one another and arranged on opposite sides of the axle drive module.

In a preferred embodiment of the invention, it is provided that in the at least one opening there is arranged at least one stiffening plate, the stiffening plate being designed to constrict the opening radially and to increase the rigidity of the drive unit.

Since the at least one stiffening plate constricts the opening, the rigidity of the frame and hence its ability to damp down vibrations is improved. The at least one stiffening plate is preferably disk-shaped and closes the opening radially completely apart from a preferably narrow passage for the drive output shaft.

Preferably at least three stiffening plates are provided, wherein one respective stiffening plate is arranged in the area of the mountings of the drive motor and a further stiffening plate is arranged in the area of the opening inlet. Since the area of the rearmost bearing of the drive motor advantageously coincides with the area of the outlet of the opening, the outlet is also constricted.

The at least one stiffening plate is preferably made of metal.

In a further preferred embodiment of the invention, it is provided that the at least one stiffening plate is designed specifically for the test object concerned and is arranged on the drive unit so that it can be exchanged.

Thus, the drive unit can be adapted quickly and simply to different axle drive modules to be tested. The test-object-specific design of the at least one stiffening plate is expressed in particular in the specific arrangement of the passage for the drive output shaft of the axle drive module concerned. Different axle drive modules usually have different radial distances between the input shaft and the drive output shaft. Moreover, the angle relative to a horizontal through the input shaft at which the drive output shaft extends can differ according to the axle drive module.

In an alternative preferred embodiment of the invention, it is provided that a drum body is arranged in the at least one opening.

Instead of one or more stiffening plates a drum body can also be arranged in the at least one opening. In that case the drum body fills the opening, preferably completely or almost completely, preferably both radially and axially.

Preferably, for its part, the drum body has at least one passage for the drive output shaft so that by virtue of the at least one passage in the drum body the drive output shaft can be guided through the at least one opening.

The at least one passage constricts the opening for the drive output shaft radially.

Preferably the drum body has a plurality of openings, which are arranged at various positions in the drum body, and which form passages of radially different size or various shapes.

Advantageously, the drum body is cylindrically shaped and is arranged in an also cylindrical opening. Thus, a passage in the drum body can be rotated to a necessary or desired circle position.

The drum body is preferably also made of metal.

In a particularly preferred embodiment of the invention, it is provided that the test bench is designed such that the drive output shaft extends alongside the drive motor at a radial distance of less than 10 cm.

In that way axle drive modules can also be tested whose input shaft is radially particularly close to the drive output shaft.

In a further preferred embodiment of the invention, it is provided that in the at least one opening there is arranged at least one bearing for the drive output shaft of the axle drive module.

This can contribute toward damping vibrations that occur at the drive output shaft of the axle drive module or at the motor shaft of the drive motor of the drive unit.

In a further preferred embodiment of the invention, it is provided that the frame has a plurality of openings, each of them designed to guide the passage of a drive output shaft of the axle drive module through the frame, parallel to the drive motor.

This has the advantage that there is a larger number of possibilities and hence greater flexibility for passing the drive output shaft of the axle drive module through the frame. In particular, in that way the testing of differently designed axle drive modules is enabled, which owing to their structures, for example have different radial distances between the input shaft of the axle drive module and the drive output shaft of the axle drive module. This also enables different clamping positions or clamping orientations for testing the axle drive module on the test bench.

In a further preferred embodiment of the invention, it is provided that the drive unit comprises a torque-measuring flange.

The torque-measuring flange is preferably accommodated in the frame.

This makes it possible for the torque applied by the drive unit on the axle drive module to be determined to a large extent precisely. Thus, the actual loading of the axle drive module can be determined and controlled comparatively more accurately.

Preferably, it is provided that the motor shaft of the drive motor is coupled by way of the torque-measuring flange to the input shaft of the axle drive module in a rotationally fixed manner. The torque-measuring flange is thus a connecting element via which the full drive power is transmitted.

Since the torque-measuring flange is also radially accommodated by the frame and in particular makes flat contact with the frame, it can also be incorporated into the drivetrain in a rigid and vibration-damping manner.

Preferably, it is provided that a rotation speed of the drive motor of the drive unit is also determined, for example by means of its control electronics system, in particular by way of its inverter. Alternatively, preferably, the rotation speed of the drive motor can be measured directly at the motor shaft by a tachometer, for example since the motor shaft is extended in such manner that it projects out of the motor housing on the b-side of the drive motor far enough for the tachometer to be arranged on it. From the known rotation speed and the known torque, for example the mechanical power acting upon the axle drive module can then be determined.

In a further preferred embodiment of the invention, it is provided that the frame consists at least partially of a mineral casting.

Mineral castings, already owing to their intrinsic material properties, have comparatively high rigidity and consequently good vibration-damping ability.

Preferably, the frame is made such that a resonance frequency of the drive unit exceeds 500 Hz. This can be achieved advantageously thanks to the structure described.

In a further preferred embodiment of the invention, it is provided that a motor shaft of the drive motor is coupled to an intermediate shaft, the intermediate shaft being held in a rotary bearing.

In this case, both the intermediate shaft and the rotary bearing are advantageously arranged within the frame, in particular accommodated radially in the frame in such manner that the rotary bearing is in contact with the frame, so enabling effective vibration damping of the rotary bearing and the intermediate shaft.

Since, when viewed axially, the intermediate shaft and the rotary bearing are arranged between the drive motor and the axle drive module, the intermediate shaft and the rotary bearing also constitute a protective barrier for the drive motor since if the axle drive module sustains any damage it can shed fragments in an explosive manner during the testing. Damage to the drive motor caused by such fragments, which can travel at very high speeds, can thereby be avoided. Instead, the fragments collide with the intermediate shaft and the rotary bearing, which are comparatively cheaper than the drive motor and can correspondingly be replaced more easily.

The invention also relates to a test bench comprising a drive unit according to the invention, a first drive output unit and a second drive output unit and a holder for the test object, wherein the first drive output unit comprises a first electric drive motor with a motor shaft, wherein the second drive output unit comprises a second electric drive motor with a motor shaft, wherein the test bench is designed to receive an electric axle drive module in the test object holder in such manner that a motor shaft of a drive input motor of the drive input unit can be coupled to an input shaft of the axle drive module, wherein the motor shaft of the electric drive motor of the first drive output unit can be coupled to a first drive output shaft of the axle drive module, and wherein the motor shaft of the electric drive input motor of the second drive unit can be coupled to a second drive output shaft of the axle drive module.

Thus, the first and second drive output units each comprise an electric drive motor, whereby they can produce a broad spectrum of rotation speeds and a continuously high torque. By way of their motor shafts, they can be coupled to a respective drive output shaft of the electric axle drive module, in particular without the interposition of a gear system.

Thus, the first and second drive output units can produce loads on the electric axle drive module to be tested, in that they produce a specifiable torque on the drive output shafts of the element axle drive module which counteracts a rotation speed and a torque that the drive unit produces at the input shaft of the electric axle drive module.

The test object holder can advantageously be adjusted longitudinally, transversely and/or vertically. Since the test object holder can be adjusted longitudinally, transversely and/or vertically, the axle drive module can to a large extent be adapted flexibly to the orientation of the drive unit and the two drive output units.

Alternatively, preferably, the test object holder can be adjusted vertically in steps exclusively by the use of connecting blocks. In that case the connecting blocks can be used in the manner of height adjustment blocks and can be attached firmly to the test bench, for example by means of screws.

The test object holder enables the axle drive module being tested to be fixed firmly onto the test bench, and in particular it largely prevents the occurrence of vibrations in the axle drive module during the testing process.

In a preferred embodiment of the invention, it is provided that the test bench also has a rail system or a cast bed with grooves, in order to enable transverse adjustability of the drive unit and/or in order to enable longitudinal adjustability of the drive unit, the first drive output unit and the second drive output unit.

In that way, the drive unit and the first and second drive output units can be orientated very flexibly in order to enable precise clamping of the test object on the test bench.

According to a particularly preferred embodiment of the invention, it is provided that the transverse adjustability amounts to at least ±300 mm.

Such a transverse adjustability has been shown in practice to be sufficient to enable various test objects to be coupled reliably to the drive unit and to the first and second drive output units.

### BRIEF DESCRIPTION OF THE DRAWINGS

Below, the invention is explained with reference to example embodiments illustrated in the figures, which show:

FIG. 1: As an example, and represented schematically, a possible embodiment of a drive unit according to the invention for a test bench for testing an electric axle drive module of a motor vehicle, as viewed in section,

FIG. 2: As an example, and represented schematically, the drive unit of FIG. 1 viewed in perspective, as seen obliquely from the front,

FIG. 3: As an example, and represented schematically, the drive unit of FIG. 1 viewed in perspective, as seen obliquely from the rear,

FIG. 4: As an example, and represented schematically, a further possible embodiment of a drive unit according to the invention,

FIG. 5: As an example, and represented schematically, a further possible embodiment of a drive unit according to the invention,

FIG. 6: As an example, and represented schematically, a further possible embodiment of a drive unit according to the invention,

FIG. 7: As an example, and represented schematically, a further possible embodiment of a drive unit according to the invention, and

FIG. 8: As an example, and represented schematically, a possible embodiment of a test bench according to the invention, as viewed from above.

The same objects, functional units and comparable components are denoted by the same indexes in all the figures. As regards their technical characteristics these objects, functional units and comparable components are designed identically unless otherwise stated explicitly or implicitly in their description.

### DETAILED DESCRIPTION

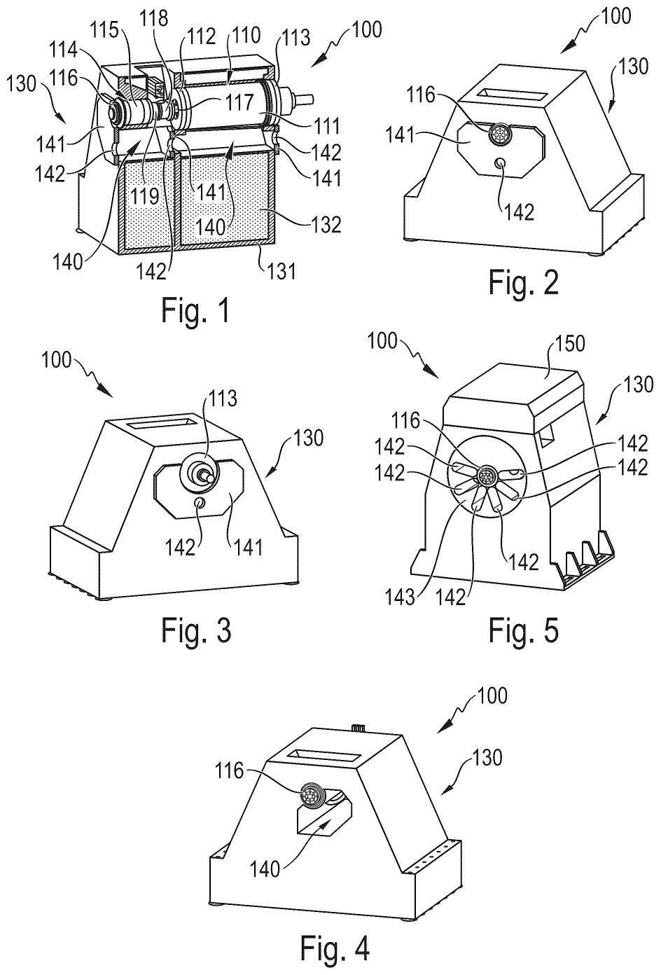

FIG. 1 shows, as an example and represented schematically, a possible embodiment of a drive unit 100 according to the invention for a test bench 200 (not shown in FIG. 1) for testing an electric axle drive module 240 (also not shown in FIG. 1) for a motor vehicle, as viewed in section.

The drive unit 100 comprises an electric drive motor 110 and a frame 130, wherein the drive motor 110 is accommodated radially by the frame 130.

In this example, the frame 130 consists of a basic metallic structure 131 which contains a mineral casting 132 on its inside. Accordingly, the frame is exceptionally rigid and vibration-damping.

The frame 130 accommodates the drive motor 110 radially in such manner that a front bearing plate 112 and a rear bearing plate 113 of the drive motor 110 are in contact with the basic metallic structure 131. The holders of the frame 130 for the bearing plates 112, 113 in this example are cast and adapted to the conical outer shape of the drive motor 110. In that way vibrations, which occur in the drive motor 110 particularly at high rotation speeds, can be effectively damped.

In this example the drive motor 110 is designed to have rotation speeds of more than 30,000 rpm.

As can also be seen, the area of the rear bearing plate 113 of the drive motor 110 is accessible from outside the frame 130. This also enables the drive motor 110 to be arranged in the frame 130 by pushing it in axially.

The drive motor 110 is held in the frame 130 in such manner that by way of its motor shaft 117 it is coupled in the area of the front bearing plate 112 to a compensation element 118 for the compensation of any slight radial misalignment. In turn, the compensation element 118 is coupled to a torque-measuring flange 119. For its part, the torque-measuring flange 119 is coupled to an intermediate shaft 114 which is held in a rotary bearing 115. At its end opposite the drive motor 110, the intermediate shaft 114 has a connecting flange 116 by way of which it can drive an axle drive module 240 (not shown in FIG. 1) directly or indirectly via an input shaft 241 (also not shown in FIG. 1) of an axle drive module 240.

The frame 130 also has an opening 140 which is designed to guide the passage of a drive output shaft 242, 243 (not shown in FIG. 1) of the axle drive module 240 though the frame 130 parallel to the drive motor 110.

This enables a drive motor 110 to be drivingly connected to the input shaft 241 of the axle drive module 240, although the drive output shaft 242, 243 of the axle drive module 240 is radially so close to the input shaft 241 that the drive output shaft 242, 243 cannot extend past the frame 130. Instead, by virtue of the opening 140 the drive output shaft 242, 243 can extend into and through the frame 130.

As can also be seen in FIG. 1, in this example three stiffening plates 141 are arranged in the opening 140 in order to constrict the opening 140 and increase the rigidity of the drive unit 100. As can be seen, the stiffening plates are essentially disk-shaped and they constrict the opening 140 radially down to a small passage diameter 142.

FIG. 2 shows, as an example and represented schematically, the drive unit 100 of FIG. 1 as viewed in perspective and obliquely from the front.

The figure shows the frame 130, a connecting flange 116 of the motor shaft 114 and a stiffening plate 141, which is arranged in the inlet area of the opening 140. The stiffening plate 141 has an aperture 142 which radially constricts the opening 140.

As an example, and represented schematically, FIG. 3 shows the drive unit 100 of FIG. 1 viewed in perspective and obliquely from the rear.

The figure again shows the frame 130, and the rear bearing plate 113 of the drive motor 110. Also visible is a stiffening plate 141, which is arranged in the outlet area of the opening 140. The stiffening plate 141 has an aperture 142 which radially constricts the opening 140.

As an example, and represented schematically, FIG. 4 shows a further possible embodiment of a drive unit 100 according to the invention.

The drive unit 100 in FIG. 4 differs from the drive unit 100 shown in FIGS. 1 to 3 as regards the structure of the opening 140. Namely, as can be seen, in the example embodiment of FIG. 4 the opening 140 is formed exclusively under and (as seen by the viewer) on the right of the connecting flange 116. This restricts the fitting possibilities for an axle drive module 240 to be tested, to orientations in which the drive output shafts 242, 243 are directed under and to the right of the connecting flange 116 and the input shaft 241 of the axle drive module 240, However, due to the correspondingly smaller opening 140 the rigidity of the drive unit 100 can again be improved.

As an example, and represented schematically, FIG. 5 shows a further possible embodiment of a drive unit 100 according to the invention.

The drive unit 100 of Fig. S differs from the drive unit 100 shown in FIGS. 1 to 4, in the structure of the opening 140.

In this example, the opening 140 is circular and surrounds the connecting flange 116 coaxially. Furthermore, instead of stiffening plates 141 a drum body 143 is provided, which is arranged in the opening 140. The drum body 143 has a plurality of longitudinal passages 142 which extend axially all the way through the drum body 143. In this case the passages 142 are arranged under and to the side of the connecting flange 116, but not above the connecting flange 116.

Thanks to the plurality of passages 142 there are also numerous ways in which the axle drive module 240 to be tested can be orientated on the test bench 200.

In the example embodiment of FIG. 5, on the frame 130 there can also be seen a terminal box 150, which contains an inverter for controlling the drive motor 110.

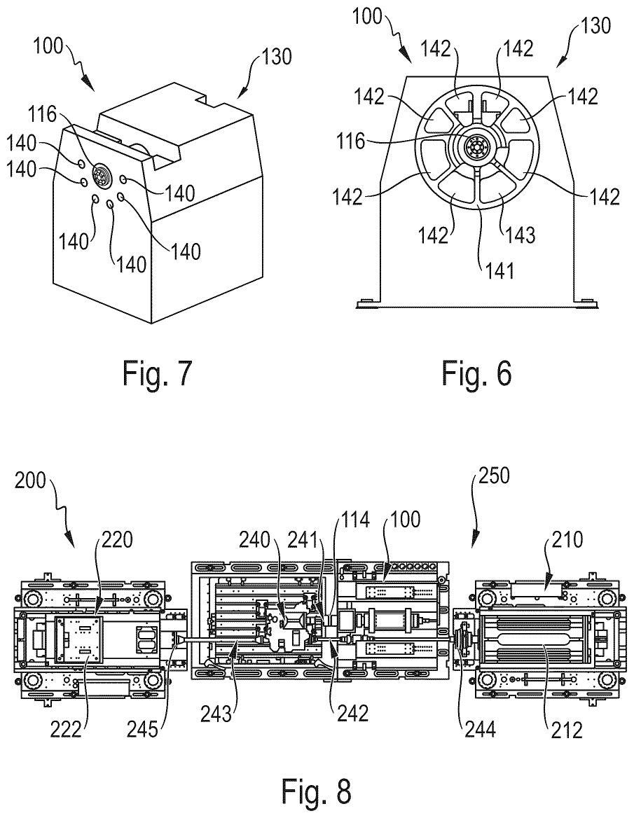

As an example, and represented schematically, FIG. 6 shows another possible embodiment of a drive unit 100 according to the invention.

The drive unit 100 in FIG. 6 differs from the drive unit 100 in FIG. 5 in the structure of the drum body 143. Instead of having numerous longitudinal passages 142 like the drum body 143 shown in FIG. 5, the drum body 143 of FIG. 6 has passages 142 which widen out toward the outer diameter of the drum body, which also extend not only under and alongside the connecting flange 116 but in addition above the connecting flange 116.

In this example, moreover, the drum body 143 shown in FIG. 6 is fitted rotatably in the opening 140 so that the position of the passages can be rotated.

FIG. 7 shows, as an example and schematically, a further possible embodiment of a drive unit 100 according to the invention.

The drive unit 100 in FIG. 7 differs from the drive units 100 in FIGS. 1 to 4 in that it has a plurality of openings 140. The openings 140 are for example in the form of bores.

As can be seen, the openings 140 in the drive unit 100 of FIG. 7 are arranged in a semicircle around the connecting flange 116. Each opening 140 can guide the passage of the drive output shaft 242, 243 of the axle drive module 240 through the frame 130.

FIG. 8 shows, as an example and schematically, a possible embodiment of a test bench 200 according to the invention, as viewed from above.

The test bench 200 comprises a drive unit 100 according to the invention, a first drive output unit 210 and a second drive output unit 220, and a test object holder (underneath the axle drive module 240 and not visible in the illustration shown as FIG. 4), in which an axle drive module 240 to be tested is held.

In this example the drive unit 100 corresponds to the drive unit 100 in FIGS. 1 to 3 and, besides the drive motor 110, also comprises the frame 130.

The first drive output unit 210 comprises an electric drive motor 210 with a motor shaft, and the second drive output unit 220 also comprises an electric drive motor 220 with a motor shaft.

The test bench 200 is designed to receive an electric axle drive module 240 in the test object holder in such manner that a motor shaft 114 of the drive unit 100 can be coupled to an input shaft 241 of the axle drive module 240.

The test bench 200 is also designed such that the motor shaft of the electric drive motor 212 of the first drive output unit 210 can be coupled to a first drive output shaft 242 of the axle drive module 240 and the motor shaft of the electric drive motor 222 of the second drive output unit 220 can be coupled to a second drive output shaft 243 of the axle drive module 240.

To couple the drive output shafts 242 and 243 to the motor shafts of the drive units 210, 220, in this example the wheel flanges 244 and 245 are used, which during the normal operation of the axle drive module 240 are provided to receive vehicle wheels.

In this example the test bench 200 also comprises a rail system 250 (not shown in greater detail), which enables the first and the second drive output units 210, 220 of the drive unit 100 and the test object holder to be moved longitudinally, so that the drive output units 210, 220, the drive unit 100 and the test object holder can be aligned with one another.

### INDEXES

100 Drive unit
110 Electric drive motor
111 Motor housing
112 Front bearing plate
113 Rear bearing plate
114 Intermediate shaft
115 Rotary bearing
116 Connecting flange
117 Motor shaft of the drive motor
118 Compensation element
119 Torque-measuring flange
130 Frame
131 Basic metallic structure
132 Mineral casting
140 Opening
141 Stiffening plate
142 Passage
143 Drum body
150 Terminal box
200 Test bench
210 First drive output unit
212 Drive motor of the first drive output unit
220 Second drive output unit
222 Drive motor of the second drive output unit
240 Axle drive module
241 Input shaft of the axle drive module
242 First drive output shaft of the axle drive module
243 Second drive output shaft of the axle drive module
244 Wheel flange
245 Wheel flange
250 Rail system

1. A drive unit (100) for a test bench for testing an electric axle drive module (240) for a motor vehicle, the drive unit comprising:
an electric drive motor (110) and a frame (130):
wherein the drive motor (110) is accommodated radially by the frame (130) and is held in the frame (130) so that the drive unit can drive an input shaft (241) of an axle drive module (240): and
wherein the frame (130) has at least one opening (140) configured to guide the passage of a drive output shaft (242, 243) of the axle drive module (240) parallel to the drive motor (110) through the frame (130).

2. The drive unit (100) according to claim 1, comprising at least one stiffening plate arranged in the at least one opening, wherein the at least one stiffening plate is configured to constrict the opening radially and to increase the rigidity of the drive unit (100).

3. The drive unit (100) according to claim 2, wherein the at least one stiffening plate is configured specifically for the test object concerned and is arranged on the drive unit (100) in such manner that it can be exchanged.

4. The drive unit (100) according to claim 1, comprising a drum body arranged in the at least one opening.

5. The drive unit (100) according to claim 1, wherein the test bench is configured so that each of the drive output shafts (242, 243) extends past the drive motor (110) a radial distance of less than 10 cm.

6. The drive unit (100) according to claim 1, comprising at least one bearing for the drive output shaft (242, 243) of the axle drive module (240) arranged in the at least one opening .

7. The drive unit (100) according to claim 1, wherein the frame (130) has a plurality of openings (140), each designed to guide the passage of a drive output shaft (242, 243) of the axle drive module (240) through the frame (130) parallel to the drive motor (110).

8. The drive unit (100) according to claim 1, comprising a torque-measuring flange,

9. The drive unit (100) according to claim 1, wherein the frame (130) comprises a mineral casting (132).

10. The Drive unit (100) according to claim 1, comprising a motor shaft (117) of the drive motor (110) and an intermediate shaft, the motor shaft (117) coupled to the intermediate shaft (114), and the intermediate shaft (114) is held in a rotary bearing (115).

11. A test bench (200), comprising:
the drive unit (100) according to claim 1;
a first drive output unit (210);
a second drive output unit (220); and
a test object holder;
wherein the first drive output unit (210) comprises a first electric drive motor (212) with a motor shaft;
wherein the second drive output unit (220) comprises a second electric drive motor (222) with a motor shaft;
wherein the test bench (200) is designed-configured to receive an electric axle drive module (240) in the test object holder in such manner that a motor shaft (117) of a drive motor (110) of the drive unit (100) can be coupled to an input shaft (241) of the axle drive module (240), the motor shaft of the electric drive motor (210) of the first drive output unit (210) can be coupled to a first drive output shaft (242) of the axle drive module (240), and the motor shaft of the electric drive motor (222) can be coupled to a second drive output shaft (243) of the axle drive module (240).

12. The test bench (200) according to claim 11, comprises-further comprising a rail system (250) or a cast bed with grooves configured to enable transverse adjustment of the drive unit (100) and/or longitudinal adjustment of the drive unit (100), the first drive output unit (210), and the second drive output unit (220).
